(19) United States
(12) Patent Application Publication
(10) Pub. No.: US 2025/0124724 A1
(43) Pub. Date: Apr. 17, 2025

(54) Method for Real-Time Detection of Road Markings

(71) Applicant: ZKW Group GmbH, Wieselburg (AT)

(72) Inventor: Oleksandr CHISTOV, Wieselburg (AT)

(21) Appl. No.: 18/912,897

(22) Filed: Oct. 11, 2024

(30) Foreign Application Priority Data
Oct. 13, 2023 (EP) 23203461.1

(51) Int. Cl. G06V 20/56; B60Q 1/14; G06V 10/141; G06V 10/26; G06V 10/50; G06V 10/56; G06V 10/764

(52) U.S. Cl. CPC G06V 20/588; G06V 10/141; G06V 10/26; G06V 10/507; G06V 10/56; G06V 10/764; B60Q 1/1415

(57) ABSTRACT

A method for real-time detection of road markings (2, 4) on a road (1) is provided, which includes the following steps: recording a colour image of a vehicle environment of a motor vehicle, transforming the colour image into a colour model with at least three colour channels, segmenting a colour channel image into a road image section and an environment image section, superimposing the road image section of a colour channel image with a grid consisting of pixel fields (3), creating histograms (5) for the pixel fields (3), classifying the histograms (5) of the pixel fields as pixels of a road marking (2, 4) or a road (1).

### CROSS-REFERENCE TO RELATED APPLICATIONS

This application claims priority to European Patent Application No. 23203461.1, filed Oct. 13, 2023, which is incorporated herein by reference.

### FIELD OF THE INVENTION

The invention relates to a method, based in particular on sensors and pattern recognition, for real-time detection of road markings and a driver assistance system for a motor vehicle. The invention further relates to a motor vehicle.

### BACKGROUND

Methods for real-time detection of road markings (for example, dashed lines, road edge markings, lane boundary lines, zebra crossings, turning arrows or general ground markings, which are preferably found on a road surface in white or yellow) are known in the prior art. In the known methods, images of a road are recorded, usually by means of a camera, and analysed using image recognition methods (e.g. pattern recognition methods). However, the known image recognition methods cannot clearly distinguish road markings from the road, in particular in unfavourable road conditions (for detection), such as when it is wet, in particular when there is a combination of wet and dark. As a result, malfunctions may occur in driver assistance systems which depend on reliable detection of road markings. In particular, lane departure warning systems, for example, require particularly accurate detection of road markings, regardless of the prevailing environmental conditions.

An object of the present invention consists in mitigating or eliminating the disadvantages of the prior art. The object of the invention is therefore in particular to create an improved method for real-time detection of road markings, which reliably detects road markings in particular in wet, dark and foggy conditions.

### SUMMARY OF THE INVENTION

According to the invention, the method, preferably based on sensors and pattern recognition, for real-time detection of road markings, in particular road edge markings, dashed lines and/or lane boundary lines, on a road surface has the following consecutive steps:
a) recording a colour image of a vehicle environment of a motor vehicle, in particular in front of or behind a motor vehicle, with a camera installed in a motor vehicle, wherein the colour image shows a road and a road environment;
b) transforming the recorded colour image into a colour model with at least three colour channels, for example into a YCbCr colour model or an RGB colour model such that each colour channel of the colour model is associated with a corresponding colour channel image of the recorded colour image;
c) segmenting at least one colour channel image, preferably all colour channel images, of the colour model into a road image section, in which only the road is shown, and an environment image section, in which only the road environment is shown, wherein the segmentation is preferably carried out by an image recognition method and/or based on sensor data of a sensor, for example a radar sensor, lidar sensor or IR sensor;
d) superimposing the road image section of at least one colour channel image, preferably all colour channel images, with a grid which is formed from a plurality of pixel fields arranged in rows and columns next to each other, wherein each pixel field is made up of N×M, preferably N×N, pixels, wherein the totality of all pixel fields form the grid which substantially completely overlays the road image section, wherein a colour value of the respective colour channel is determined for each pixel in each pixel field, wherein the determined colour value is a value within the specific colour spectrum of the respective colour channel;
e) creating histograms for the pixel fields of at least one colour channel, preferably all colour channels, of the colour model, wherein the pixels of the pixel fields are grouped in a histogram by their determined colour value such that the histogram constitutes a frequency distribution in which a number of pixels with a specific colour value of the colour spectrum of the respective colour channel is mapped against the entire colour spectrum of the respective colour channel;
f) classifying the histograms of the individual pixel fields for at least one colour channel, preferably for all colour channels, in such a way that if, in a histogram, the number of pixels of a specific colour value lies within one of a plurality of defined colour value intervals, which respectively define a different sub-range of the colour spectrum of the colour channel, the number of pixels of the specific colour value is associated with the colour value interval in which it lies, wherein the plurality of defined colour value intervals comprise characteristic colour values for a road marking or a road in the corresponding colour model such that the number of pixels associated with the specific colour value interval is classified as pixels of a road marking or a road.

This has the advantage that the information obtained from several colour channels can be combined to obtain a more accurate result when detecting road markings. In particular, the classification of the histograms of each colour channel image of each colour channel provides information on the presence of road markings, and this (colour channel-specific) information can be combined to increase the accuracy when detecting road markings. For example, if no road marking is detected in a colour channel (or in a colour channel image) because, for example, the road conditions do not allow for this, a road marking can nevertheless be detected in one of the two other colour channels. This can thus improve the detection of road markings, in particular when the road is wet and/or it is dark. The camera is preferably a digital camera, which is installed, for example, in a motor vehicle or is part of a sensor system of a motor vehicle. In the context of the present disclosure, pattern recognition can be understood as structural pattern recognition methods, which are generally known to a person skilled in the art, wherein such a pattern recognition method can combine various syntactic and/or statistical methods. In a known manner, such pattern recognition methods can comprise steps, such as data collection, pre-processing the collected data, feature extraction, if necessary feature reduction and then classification.

It may be provided that the method has the further optional step of: providing a drive assistance system, in particular a lane departure warning system, and transmitting the detected road marking to the drive assistance system, wherein the drive assistance system is designed to actuate control, illumination or signalling devices of a motor vehicle based on the transmitted detected road marking, wherein the position of the detected road markings is preferably also visually displayed on a screen of an on-board computer of a motor vehicle.

It may be provided that the method has the further optional step of: determining the position of the motor vehicle, for example by means of GPS, and transmitting the position of the motor vehicle, the detected road marking and the road recorded by the camera to a drive assistance system of a motor vehicle, in particular a lane departure warning system, and preferably displaying a visual representation of the motor vehicle, the detected road marking and the road recorded by the camera, in particular in real time, on a screen of an on-board computer of a motor vehicle.

It may be provided that the colour image is made up of a greater number of pixels than a pixel field of the grid, wherein the colour image is preferably made up of N′×M′ pixels, wherein N′ is at least more than 5 times, preferably more than 10 times, in particular more than 100 times, larger than N, and/or wherein M′ is at least more than 5 times, preferably more than 10 times, in particular more than 100 times, larger than M.

It may be provided that the pixel comparison is performed according to step f) with a cross-correlation function.

It may be provided that during segmentation according to step c), traffic objects which have preferably been determined using image recognition methods and/or detected by a sensor, for example a radar sensor, lidar sensor or IR sensor, are filtered out of the colour channel image by means of image recognition algorithms, for example.

It may be provided that the individual pixel fields are arranged in a uniform grid, wherein neighbouring pixel fields are preferably arranged directly adjacent to one another or without a gap between them.

It may be provided that the method comprises the further optional steps of:
g1) providing a, preferably adaptive, motor vehicle headlight with a control device for controlling the light functions which can be produced with the motor vehicle headlight;
g2) analysing, for example using a machine learning algorithm, a colour channel image in which a road marking has been detected in accordance with steps c) to f), wherein during the analysis a defined image section is determined in the colour channel image which is free of a detected road marking, wherein a road marking should be present in the defined image section in accordance with the analysis,
g3) transmitting the defined image section to the control device of the motor vehicle headlight, wherein the control device is designed, in response to the transmitted defined image section, to control the motor vehicle headlight in such a way that an environment of the motor vehicle headlight which corresponds to the transmitted defined image section is illuminated with light from the motor vehicle headlight or is illuminated more strongly compared to another environment, wherein the light illuminating the environment is preferably emitted by a light module of the motor vehicle headlight, preferably by an adaptive light source of the motor vehicle headlight,
g4) recording another colour image of a vehicle environment, wherein the recorded vehicle environment has the environment illuminated in step g3);
g5) carrying out steps b) to f) with the colour image recorded in step g4).

It may be provided that the motor vehicle headlight has a pixel light source or a high-resolution light source, wherein in order to increase the illumination, in particular the contrast, of the colour image recorded in step g4)
the illumination of the environment which corresponds to the transmitted image section is increased by controlling the pixel light source accordingly, or
the illumination intensity of the pixel light source is synchronized with the shutter of the camera, or
an exposure time of the camera is increased in step g4) compared to a basic exposure time value set in step a).

It may be provided that the method comprises the further optional step of:
analysing, for example using a machine learning algorithm, a colour channel image in which a road marking has been detected in accordance with steps c) to f), wherein during the analysis a defined image section is determined in the colour channel image which is free of a detected road marking, wherein a road marking should be present in the defined image section in accordance with the analysis,

wherein the classification according to step f) is carried out for the defined image section with an adapted, in particular a larger or smaller, defined colour value interval, such that a number of pixels of a specific colour value in a histogram, which would lie outside the original colour interval, lies within the adapted colour interval.

It may be provided that the method comprises the further optional step of:
providing a sensor, for example a radar sensor, lidar sensor or IR sensor, for detecting road markings;
analysing, for example using a machine learning algorithm, a colour channel image in which a road marking has been detected in accordance with steps c) to f), wherein during the analysis a defined image section is determined in the colour channel image which is free of a detected road marking, wherein a road marking should be present in the defined image section in accordance with the analysis;
detecting the defined image section with the sensor in order to determine a road marking not detected in step f) with the sensor.

It may be provided that the pixel comparison is performed in the pixel fields one after the other, row-by-row or column-by-column, until all pixel fields of the entire grid have been compared, wherein the pixel comparison within the pixel fields preferably takes place simultaneously for the entire grid, wherein the comparison of pixels of a pixel field takes place respectively on different CPU cores or threads.

According to another aspect of the invention, a driver assistance system for a motor vehicle is provided, wherein the driver assistance system is designed for real-time detection of road markings, in particular road edge markings, dashed lines and/or lane boundary lines, on a road surface, wherein the driver assistance system is designed

to receive a colour image of a vehicle environment of a motor vehicle, in particular in front of or behind a motor vehicle, recorded with a camera of a motor vehicle;

to transform the recorded colour image into a colour model with at least three colour channels, for example into a YCbCr colour model or an RGB colour model such that each colour channel of the colour model is associated with a corresponding colour channel image of the recorded colour image;

to segment the at least one colour channel image, preferably all colour channel images, of the colour model into a road image section, in which only the road is shown, and an environment image section, in which only the road environment is shown, wherein the segmentation is preferably carried out by an image recognition method and/or based on sensor data of a sensor, for example a radar sensor, lidar sensor or IR sensor;

to superimpose the road image section of at least one colour channel image, preferably all colour channel images, with a grid which is formed from a plurality of pixel fields arranged in rows and columns next to each other, wherein each pixel field is made up of N×M, preferably N×N, pixels, wherein the totality of all pixel fields form the grid which substantially completely overlays the road image section, wherein a colour value of the respective colour channel is determined for each pixel in each pixel field, wherein the determined colour value is a value within the specific colour spectrum of the respective colour channel;

to create histograms for pixel fields of at least one colour channel, preferably all colour channels, of the colour model, wherein the pixels of the pixel fields are grouped in a histogram by their determined colour value such that a histogram constitutes a frequency distribution in which a number of pixels with a specific colour value of the colour spectrum of the respective colour channel is mapped against the entire colour spectrum of the respective colour channel;

to classify the histograms of the individual pixel fields for at least one colour channel, preferably for all colour channels, in such a way that if, in a histogram, the number of pixels of a specific colour value lies within one of a plurality of defined colour value intervals, which respectively define a different sub-range of the colour spectrum of the colour channel, the number of pixels of the specific colour value is associated with the colour value interval in which it lies, wherein the plurality of defined colour value intervals comprise characteristic colour values for a road marking or a road in the corresponding colour model such that the number of pixels associated with the specific colour value interval is classified as pixels of a road marking or a road.

It may be provided that the characteristic colour values for a road marking or a road are stored in a memory of the driver assistance system.

Furthermore, a motor vehicle comprising a driver assistance system may be provided.

### BRIEF DESCRIPTION OF THE DRAWINGS

The invention is outlined in more detail below based on a preferred exemplary embodiment, to which it is, however, not limited. In the drawings:

FIG. 1 shows a flowchart of the method steps of a method according to the invention;

FIG. 2 shows a schematic view of a road;

FIG. 3 shows a histogram for a pixel field of a colour channel;

FIG. 4 shows a histogram for a further pixel field of the colour channel.

### DETAILED DESCRIPTION

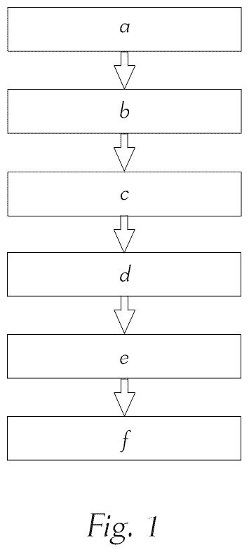

FIG. 1 shows a flowchart of the method steps of a method for real-time detection of road markings 2, in particular road edge markings, dashed lines and/or lane boundary lines, on a road surface.

The method for real-time detection comprises the following consecutive steps:
a) recording a colour image of a vehicle environment of a motor vehicle, in particular in front of or behind a motor vehicle, with a camera installed in a motor vehicle, wherein the colour image shows a road 1 and a road environment 2.
b) transforming the recorded colour image into a colour model with at least three colour channels, for example into a YCbCr colour model or an RGB colour model such that each colour channel of the colour model is associated with a corresponding colour channel image of the recorded colour image.
c) segmenting at least one colour channel image, preferably all colour channel images, of the colour model into a road image section, in which only the road 1 is shown, and an environment image section, in which only the road environment 2 is shown, wherein the segmentation is preferably carried out by an image recognition method and/or based on sensor data of a sensor, for example a radar sensor, lidar sensor or IR sensor.
d) superimposing the road image section of at least one colour channel image, preferably all colour channel images, with a grid which is formed from a plurality of pixel fields arranged in rows and columns next to each other, wherein each pixel field is made up of N×M, preferably N×N, pixels, wherein the totality of all pixel fields form the grid which substantially completely overlays the road image section, wherein a colour value of the respective colour channel is determined for each pixel in each pixel field, wherein the determined colour value is a value within the specific colour spectrum of the respective colour channel.
e) creating histograms 5 for the pixel fields of at least one colour channel, preferably all colour channels, of the colour model, wherein the pixels of the pixel fields are grouped in a histogram 5 by their determined colour value such that the histogram 5 constitutes a frequency distribution in which a number of pixels with a specific colour value of the colour spectrum of the respective colour channel is mapped against the entire colour spectrum of the respective colour channel.
f) classifying the histograms 5 of the individual pixel fields for at least one colour channel, preferably for all colour channels, in such a way that if, in a histogram 5, the number of pixels of a specific colour value lies within one of a plurality of defined colour value intervals, which respectively define a different sub-range of the colour spectrum of the colour channel, the number of pixels of the specific colour value is associated with the colour value interval in which it lies, wherein the plurality of defined colour value intervals comprise characteristic colour values for a road marking 2 or a road in the corresponding colour model such that the number of pixels associated with the specific colour value interval is classified as pixels of a road marking 2 or a road 1.

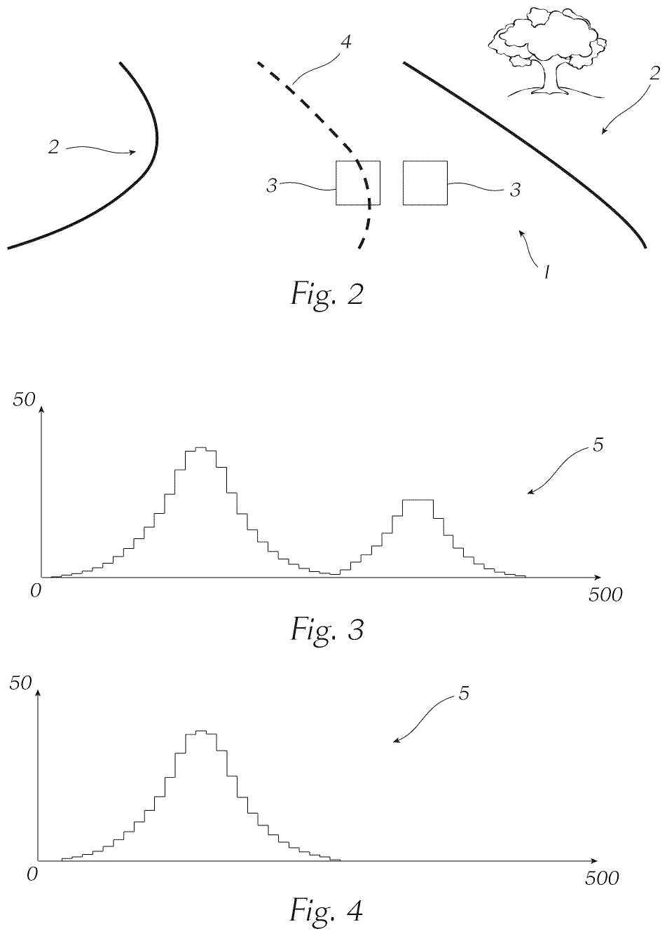

FIG. 2 shows a schematic image of a vehicle environment with a road 1, which has road markings 2, 4 (in this example, a left-hand and right-hand road edge marking 2 and a central dashed line 4). The image is an exemplary schematic illustration of an image which is recorded in method step a).

In the road image section of the image, two (in the example shown, square) pixel fields 3 of a pixel field grid are shown, which overlay the road image section. Each pixel field 3 is formed from a plurality of pixels (not shown) arranged in rows and columns next to each other, wherein a pixel field 3 can be made up of N×M, preferably N×N, pixels. The image has a resolution of N′×M′, wherein N′>N and M′>M.

The left-hand pixel field 3 can overlay the road image section at a time t0 and travel further rightwards at a later time t1 (until the entire road image section has been scanned). Alternatively to scanning with a pixel field, the left-hand pixel field 3 and the right-hand pixel field 3 (as well as many further pixel fields) can also overlay the road image section at the same time. If a plurality of pixel fields 3 overlay the road image section at the same time, each pixel field 3 can be associated with a CPU core or a thread in order to enable simultaneous evaluation of the pixel fields.

FIG. 3 shows a histogram 5 of the left-hand pixel field 3 shown in FIG. 2 for a colour channel. FIG. 4 shows a histogram 5 of the right-hand pixel field 3 shown in FIG. 2 for the same colour channel.

In each of the two histograms 5, a colour value between 0 and 500 is shown on the X axis for a colour channel of a colour model, for example the Y value of the YCbCr colour model. The Y-axis of the two histograms 5 shows the number of pixels (the Y axis value in the histograms 5 thus corresponds to the number of pixels which have the corresponding colour value of the colour channel (on the X axis)).

The left-hand pixel field 3 in FIG. 2 overlays a road section and a road marking, in this case three partial dashed lines of the central dashed line 4 of the road 1. Those pixels of the pixel field 3 which overlay the road section (i.e. for example the dark tarmac), have a lower colour value (in the colour model) according to method step e) than those pixels of the pixel field 3 which overlay the partial dashed lines of the central dashed line 4 (which, for example, is in white).

The pixels of the left-hand pixel field 3 in FIG. 2, which overlay the road section, correspond to the left-hand peak in the histogram 5 shown in FIG. 3. The pixels of the left-hand pixel field 3 in FIG. 2, which overlay the central dashed line 4, correspond to the right-hand peak in the histogram 5 shown in FIG. 3 (as the pixels which overlay the white central dashed line 4 have a higher Y value in the YCbCr colour model than those pixels which overlay the dark tarmac). According to method step f), the pixels of the left-hand peak can thus be classified as road 1 and the pixels of the right-hand peak as road marking.

The right-hand pixel field 3 shown in FIG. 2 overlays only a road 1, but no road marking or no central dashed line 4. As such, all pixels in the right-hand pixel field 3 have a similar colour value according to method step e). In the histogram 5 shown in FIG. 4 corresponding to the right-hand pixel field 3, only one peak is thus shown, wherein according to method step f), the pixels of the left-hand peak are dark (or have a low colour value in the colour model) and are thus classified as road 1.

### REFERENCE LIST

1 road
2 road edge marking
3 pixel field
4 central dashed line
5 histogram

1. A method for real-time detection of road markings (2, 4), in particular road edge markings, dashed lines and/or lane boundary lines, on a road surface, wherein the method for real-time detection comprises the following consecutive steps:
a) recording a colour image of a vehicle environment of a motor vehicle, in particular in front of or behind a motor vehicle, with a camera installed in a motor vehicle, wherein the colour image shows a road (1) and a road environment;
b) transforming the recorded colour image into a colour model with at least three colour channels, for example into a YCbCr colour model or an RGB colour model such that each colour channel of the colour model is associated with a corresponding colour channel image of the recorded colour image;
c) segmenting at least one colour channel image, preferably all colour channel images, of the colour model into a road image section, in which only the road (1) is shown, and an environment image section, in which only the road environment is shown, wherein the segmentation is preferably carried out by an image recognition method and/or based on sensor data of a sensor, for example a radar sensor, lidar sensor or IR sensor;
d) superimposing the road image section of at least one colour channel image, preferably all colour channel images, with a grid which is formed from a plurality of pixel fields arranged in rows and columns next to each other, wherein each pixel field is made up of N×M, preferably N×N, pixels, wherein the totality of all pixel fields form the grid which substantially completely overlays the road image section, wherein a colour value of the respective colour channel is determined for each pixel in each pixel field, wherein the determined colour value is a value within the specific colour spectrum of the respective colour channel;
e) creating histograms (5) for the pixel fields of at least one colour channel, preferably all colour channels, of the colour model, wherein the pixels of the pixel fields are grouped in a histogram (5) by their determined colour value such that the histogram (5) constitutes a frequency distribution in which a number of pixels with a specific colour value of the colour spectrum of the respective colour channel is mapped against the entire colour spectrum of the respective colour channel; and
f) classifying the histograms (5) of the individual pixel fields for at least one colour channel, preferably for all colour channels, in such a way that if, in a histogram (5), the number of pixels of a specific colour value lies within one of a plurality of defined colour value intervals, which respectively define a different sub-range of the colour spectrum of the colour channel, the number of pixels of the specific colour value is associated with the colour value interval in which it lies, wherein the plurality of defined colour value intervals comprise characteristic colour values for a road marking (2, 4) or a road (1) in the corresponding colour model such that the number of pixels associated with the specific colour value interval is classified as pixels of a road marking (2, 4) or a road (1).

2. The method according to claim 1, wherein the method further comprises:
providing a drive assistance system, in particular a lane departure warning system, and transmitting the detected road marking (2, 4) to the drive assistance system, wherein the drive assistance system is designed to actuate control, illumination or signalling devices of a motor vehicle based on the transmitted detected road marking (2, 4), wherein the position of the detected road marking (2, 4) is preferably also visually displayed on a screen of an on-board computer of a motor vehicle.

3. The method according to claim 1, wherein the method further comprises:
determining the position of the motor vehicle, for example by means of GPS, and transmitting the position of the motor vehicle, the detected road marking (2, 4) and the road (1) recorded by the camera to a drive assistance system of a motor vehicle, in particular a lane departure warning system, and preferably displaying a visual representation of the motor vehicle, the detected road marking (2, 4) and the road (1) recorded by the camera, in particular in real time, on a screen of an on-board computer of a motor vehicle.

4. The method according to claim 1, wherein the colour image is made up of a greater number of pixels than a pixel field of the grid, wherein the colour image is preferably made up of N′×M′ pixels, wherein N′ is at least more than 5 times, preferably more than 10 times, in particular more than 100 times, larger than N, and/or wherein M′ is at least more than 5 times, preferably more than 10 times, in particular more than 100 times, larger than M.

5. The method according to claim 1, wherein the pixel comparison is performed according to step f) with a cross-correlation function, wherein, during segmentation according to step c), traffic objects which have preferably been determined using image recognition methods and/or detected by a sensor, for example a radar sensor, lidar sensor or IR sensor, are preferably filtered out of the colour channel image by means of image recognition algorithms, for example.

6. The method according to claim 1, wherein the individual pixel fields are arranged in a uniform grid, wherein neighbouring pixel fields are preferably arranged directly adjacent to one another or without a gap between them.

7. The method according to claim 1, wherein the method further comprises:
g1) providing a, preferably adaptive, motor vehicle headlight with a control device for controlling the light functions which can be produced with the motor vehicle headlight;
g2) analysing, for example using a machine learning algorithm, a colour channel image in which a road marking (2, 4) has been detected in accordance with steps c) to f), wherein during the analysis a defined image section is determined in the colour channel image which is free of a detected road marking (2, 4), wherein a road marking (2, 4) should be present in the defined image section in accordance with the analysis,
g3) transmitting the defined image section to the control device of the motor vehicle headlight, wherein the control device is designed, in response to the transmitted defined image section, to control the motor vehicle headlight in such a way that an environment of the motor vehicle headlight which corresponds to the transmitted defined image section is illuminated with light from the motor vehicle headlight or is illuminated more strongly compared to another environment, wherein the light illuminating the environment is preferably emitted by a light module of the motor vehicle headlight, preferably by an adaptive light source of the motor vehicle headlight,
g4) recording another colour image of a vehicle environment, wherein the recorded vehicle environment has the environment illuminated in step g3); and
g5) carrying out steps b) to f) with the colour image recorded in step g4).

8. The method according to claim 7, wherein the motor vehicle headlight has a pixel light source or a high-resolution light source, wherein in order to increase the illumination, in particular the contrast, of the colour image recorded in step g4):
the illumination of the environment which corresponds to the transmitted image section is increased by controlling the pixel light source accordingly, or
the illumination intensity of the pixel light source is synchronized with the shutter of the camera, or
an exposure time of the camera is increased in step g4) compared to a basic exposure time value set in step a).

9. The method according to claim 1, wherein the method further comprises:
analysing, for example using a machine learning algorithm, a colour channel image in which a road marking (2, 4) has been detected in accordance with steps c) to f), wherein during the analysis a defined image section is determined in the colour channel image which is free of a detected road marking (2, 4), wherein a road marking (2, 4) should be present in the defined image section in accordance with the analysis,
wherein the classification according to step f) is carried out for the defined image section with an adapted, in particular a larger or smaller, defined colour value interval, such that a number of pixels of a specific colour value in a histogram (5), which would lie outside the original colour interval, lies within the adapted colour interval.

10. The method according to claim 1, wherein the method further comprises:
providing a sensor, for example a radar sensor, lidar sensor or IR sensor, for detecting road markings (2, 4);
analysing, for example using a machine learning algorithm, a colour channel image in which a road marking (2, 4) has been detected in accordance with steps c) to f), wherein during the analysis a defined image section is determined in the colour channel image which is free of a detected road marking (2, 4), wherein a road marking (2, 4) should be present in the defined image section in accordance with the machine learning algorithm; and
detecting the defined image section with the sensor in order to determine a road marking (2, 4) not detected in step f) with the sensor.

11. The method according to claim 1, wherein the pixel comparison is performed in the pixel fields one after the other, row-by-row or column-by-column, until all pixel fields of the entire grid have been compared.

12. The method according to claim 1, wherein the pixel comparison within the pixel fields takes place simultaneously for the entire grid, wherein the comparison of pixels of a pixel field takes place respectively on different CPU cores or threads.

13. A driver assistance system for a motor vehicle, wherein the driver assistance system is configured for real-time detection, in accordance with the method according to claim 1, of road markings (2, 4), in particular road edge markings, dashed lines and/or lane boundary lines, on a road surface, wherein the driver assistance system is configured to:
receive a colour image of a vehicle environment of a motor vehicle, in particular in front of or behind a motor vehicle, recorded with a camera of a motor vehicle;
transform the recorded colour image into a colour model with at least three colour channels, for example into a YCbCr colour model or an RGB colour model such that each colour channel of the colour model is associated with a corresponding colour channel image of the recorded colour image;
segment the at least one colour channel image, preferably all colour channel images, of the colour model into a road image section, in which only the road is shown, and an environment image section, in which only the road environment is shown, wherein the segmentation is preferably carried out by an image recognition method and/or based on sensor data of a sensor, for example a radar sensor, lidar sensor or IR sensor;
superimpose the road image section of at least one colour channel image, preferably all colour channel images, with a grid which is formed from a plurality of pixel fields arranged in rows and columns next to each other, wherein each pixel field is made up of N×M, preferably N×N, pixels, wherein the totality of all pixel fields form the grid which substantially completely overlays the road image section, wherein a colour value of the respective colour channel is determined for each pixel in each pixel field, wherein the determined colour value is a value within the specific colour spectrum of the respective colour channel;
create histograms (5) for pixel fields of at least one colour channel, preferably all colour channels, of the colour model, wherein the pixels of the pixel fields are grouped in a histogram (5) by their determined colour value such that a histogram (5) constitutes a frequency distribution in which a number of pixels with a specific colour value of the colour spectrum of the respective colour channel is mapped against the entire colour spectrum of the respective colour channel; and
classify the histograms (5) of the individual pixel fields for at least one colour channel, preferably for all colour channels, in such a way that if, in a histogram (5), the number of pixels of a specific colour value lies within one of a plurality of defined colour value intervals, which respectively define a different sub-range of the colour spectrum of the colour channel, the number of pixels of the specific colour value is associated with the colour value interval in which it lies, wherein the plurality of defined colour value intervals comprise characteristic colour values for a road marking (2, 4) or a road in the corresponding colour model such that the number of pixels associated with the specific colour value interval is classified as pixels of a road marking (2, 4) or a road.

14. The driver assistance system according to claim 13, wherein the characteristic colour values for a road marking (2, 4) or a road (1) are stored in a memory of the driver assistance system.

15. A motor vehicle comprising the driver assistance system according to claim 13.
